(19) United States
(12) Patent Application Publication
(10) Pub. No.: US 2018/0149322 A1
(43) Pub. Date: May 31, 2018

(54) INFORMATION-PROCESSING APPARATUS AND INFORMATION-PROCESSING METHOD

(71) Applicant: CANON KABUSHIKI KAISHA, Tokyo (JP)

(72) Inventor: Mitsuru Tada, Machida-shi (JP)

(21) Appl. No.: 15/814,547

(22) Filed: Nov. 16, 2017

(30) Foreign Application Priority Data
Nov. 30, 2016 (JP) 2016-232504

(51) Int. Cl. F21K 9/64; G02F 1/1335; F21V 8/00

(52) U.S. Cl. CPC F21K 9/64; G02F 1/133603; F21K 2099/005; G02B 6/0055; G02B 6/0051

(57) ABSTRACT

An information-processing apparatus configured to estimate a distribution of light emitted from a light-emitting apparatus, the information-processing apparatus including: at least one processor; and at least one memory storing a program which, when executed by the at least one processor, causes the information-processing apparatus to: acquire profile data related to a first distribution of light emitted from the light-emitting apparatus in a first emission pattern; estimate, based on the profile data and a second emission pattern, a second distribution of light emitted from the light-emitting apparatus in the second emission pattern; and correct the estimated second distribution based on a difference between the first emission pattern and the second emission pattern.

### BACKGROUND OF THE INVENTION

### Field of the Invention

The present invention relates to an information-processing apparatus and an information-processing method.

### Description of the Related Art

While cold cathode fluorescent tubes (CCFLs) have been conventionally used as a light source of a backlight apparatus for liquid crystal display apparatuses, more and more backlight apparatuses use light-emitting diodes (LEDs) as light sources in recent years. Since an LED is a point light source, in a case where an LED is used as a light source of a backlight apparatus, an occurrence of non-uniformity (brightness non-uniformity, color non-uniformity, and the like) in light emitted from the backlight apparatus must be suppressed by exercising ingenuity in an LED arrangement, a diffusion structure of light, a reflection structure of light, and the like. In particular, with a backlight apparatus using a plurality of LEDs with mutually different emission colors, since above-described non-uniformity is more likely to occur, the ingenuity described above is required. As a plurality of LEDs with mutually different emission colors, for example, an R-LED that emits red light, a G-LED that emits green light, a B-LED that emits blue light, and the like are used.

In addition, a light-emitting apparatus including a B-LED and a wavelength converting member having an R phosphor and a G phosphor is being proposed. The R phosphor is a phosphor that emits red light due to excitation caused by blue light. The G phosphor is a phosphor that emits green light due to excitation caused by blue light. In the light-emitting apparatus described above, a part of the blue light from the B-LED is converted into red light by the R phosphor and the red light is emitted from the wavelength converting member. In addition, a part of the blue light from the B-LED is converted into green light by the G phosphor and the green light is emitted from the wavelength converting member. Furthermore, a part of the blue light from the B-LED is emitted from (transmitted through) the wavelength converting member without being converted thereby. As a result, since composite light that combines blue light, red light, and green light is emitted from the light-emitting apparatus, light with a wide color gamut can be obtained as light from the light-emitting apparatus.

In recent years, a quantum dot is proposed as a phosphor (a wavelength conversion element) capable of generating light with high purity by induced excitation. A quantum dot is a phosphor that emits light in accordance with a particle size of the quantum dot in response to ultraviolet light, blue light, and the like. Since the use of a quantum dot enables light (red light, green light, and the like) with a half-value width of around 40 nm to be obtained from blue light, light with a wider color gamut can be obtained as light emitted from the light-emitting apparatus. A light-emitting apparatus using a quantum dot is disclosed in, for example, Japanese Translation of PCT Application No. 2016-510909. With the technique disclosed in Japanese Translation of PCT Application No. 2016-510909, a sheet-like member (a quantum dot sheet) containing quantum dots is used as a wavelength converting member.

In addition, as a technique related to a backlight apparatus, a technique for individually controlling emission brightness of a plurality of LEDs is proposed. Individually controlling the emission brightness of a plurality of LEDs enables emission brightness of the backlight apparatus to be partially modified. Such control is referred to as “local dimming control”. For example, in local dimming control, for each of a plurality of divided display areas that constitute a screen, a process involving analyzing a brightness value of image data and controlling emission brightness of an LED based on a result of the brightness value analysis is performed to increase contrast of a display image.

Every time light from an LED is reflected by an optical member, a wavelength converting member, or the like, spectral characteristics of the light from the LED vary. In addition, every time the light from the LED is transmitted through an optical member, a wavelength converting member, or the like, the spectral characteristics of the light from the LED vary. Examples of an optical member include a reflective plate, a reflective sheet, a diffuser plate, a diffuser sheet, a brightness enhancement film (BEF), and a dual brightness enhancement film (DBEF). In a case where a wavelength converting member containing a quantum dot is used in a light-emitting apparatus, the spectral characteristics of light from an LED vary in accordance with a distance that the light from the LED travels when being transmitted through the wavelength converting member, the number of times the light from the LED strikes the quantum dot, and the like.

A case will now be considered in which a wavelength converting member includes a quantum dot that converts blue light into green light and a quantum dot that converts blue light into red light. In this case, the color of light emitted from the light-emitting apparatus approaches yellow as the number of times blue light from a B-LED strikes a quantum dot. For example, with light (leakage light) leaking from a B-LED corresponding to a certain divided display area into another divided display area, the distance that blue light from the B-LED travels when being transmitted through the wavelength converting member is long and the number of times the blue light from the B-LED strikes a quantum dot is large. Therefore, the color of light emitted from the light-emitting apparatus is made to approach yellow by the leakage light. Due to the color of light emitted from the light-emitting apparatus approaching yellow, brightness of the light emitted from the light-emitting apparatus also increases.

Therefore, a shift (a color shift, a brightness shift, or the like) between the light emitted from the light-emitting apparatus and desired light may occur. In addition, in local dimming control, since the emission brightness of a plurality of LEDs is individually controlled, light leaking from an LED corresponding to a certain divided display area into another divided display area varies. As a result, non-uniformity (brightness non-uniformity, color non-uniformity, or the like) in which the shift described above varies among a plurality of divided display areas may occur.

As a technique for solving such problems, for example, a technique disclosed in Japanese Translation of PCT Application No. 2016-510909 is proposed. With the technique disclosed in Japanese Translation of PCT Application No. 2016-510909, image data is corrected (color shift correction) in accordance with blue light profile data, yellow light profile data, and distances from a light source to respective positions of a liquid crystal panel. The blue light profile data indicates a distribution of blue light emitted from the light source and emitted from a backlight apparatus, and the yellow light profile data indicates a distribution of yellow light emitted from the light source and emitted from the backlight apparatus.

### SUMMARY OF THE INVENTION

However, due to various factors including the variance in spectral characteristics described above, a shape of a distribution of light emitted from the light source and emitted from the backlight apparatus varies depending on a light emission pattern of the light-emitting apparatus. With the technique disclosed in Japanese Translation of PCT Application No. 2016-510909, since profile data is fixed, information representing, with high accuracy, the distribution of light emitted from the light-emitting apparatus cannot be obtained and highly accurate color shift correction cannot be performed.

The present invention in its first aspect provides an information-processing apparatus configured to estimate a distribution of light emitted from a light-emitting apparatus including a plurality of light source units, the information-processing apparatus comprising:

at least one processor; and

at least one memory storing a program which, when executed by the at least one processor, causes the information-processing apparatus to:

acquire profile data related to a first distribution that is a distribution of light emitted from the light-emitting apparatus in a first emission pattern in which one light source unit in the plurality of light source units emits light;

estimate, based on the profile data and a second emission pattern in which two or more light source units in the plurality of light source units emit light, a second distribution that is a distribution of light emitted from the light-emitting apparatus in the second emission pattern; and

correct the estimated second distribution based on a difference between the first emission pattern and the second emission pattern.

The present invention in its second aspect provides a light-emitting apparatus comprising the above mentioned information-processing apparatus.

The present invention in its third aspect provides a display apparatus comprising:

a light-emitting apparatus;

a display unit configured to display an image by modulating, based on input image data, light emitted from the light-emitting apparatus, and

the above mentioned information-processing apparatus.

The present invention in its fourth aspect provides an information-processing method for estimating a distribution of light emitted from a light-emitting apparatus including a plurality of light source units, the information-processing method comprising:

acquiring profile data related to a first distribution that is a distribution of light emitted from the light-emitting apparatus in a first emission pattern in which one light source unit in the plurality of light source units emits light;

estimating, based on the profile data and a second emission pattern in which two or more light source units in the plurality of light source units emit light, a second distribution that is a distribution of light emitted from the light-emitting apparatus in the second emission pattern; and

correcting the estimated second distribution based on a difference between the first emission pattern and the second emission pattern.

The present invention in its fifth aspect provides a non-transitory computer readable medium that stores a program, wherein

the program causes a computer to execute an information-processing method for estimating a distribution of light emitted from a light-emitting apparatus including a plurality of light source units, and

the information-processing method includes:

acquiring profile data related to a first distribution that is a distribution of light emitted from the light-emitting apparatus in a first emission pattern in which one light source unit in the plurality of light source units emits light;

estimating, based on the profile data and a second emission pattern in which two or more light source units in the plurality of light source units emit light, a second distribution that is a distribution of light emitted from the light-emitting apparatus in the second emission pattern; and

correcting the estimated second distribution based on a difference between the first emission pattern and the second emission pattern.

Further features of the present invention will become apparent from the following description of exemplary embodiments with reference to the attached drawings.

### BRIEF DESCRIPTION OF THE DRAWINGS

FIGS. 1A to 1C show an example of a cross section of a light-emitting apparatus according to the present embodiment;

FIG. 2 shows an example of a correspondence relationship between a light emission pattern and color according to the present embodiment;

FIG. 3 shows an example of an error reduced in the present embodiment;

FIG. 4 shows an example of a configuration of a display apparatus according to the present embodiment;

FIG. 5 shows an example of a divided display area according to the present embodiment; and

FIGS. 6A to 6C show an example of profile data according to the present embodiment.

### DESCRIPTION OF THE EMBODIMENTS

An embodiment of the present invention will be described below. An information-processing apparatus according to the present embodiment estimates a distribution of light emitted from a light-emitting apparatus.

Hereinafter, an example in which a display apparatus that displays an image on a screen by modulating light emitted from a light-emitting apparatus includes an information-processing apparatus will be described. Alternatively, the information-processing apparatus may be a separate apparatus from the display apparatus. For example, the information-processing apparatus may be a personal computer (PC) that is separate from the display apparatus.

In addition, the light-emitting apparatus is not limited to an apparatus used in a display apparatus. For example, the light-emitting apparatus may also be a lighting apparatus such as a street lamp, an indoor lighting fixture, and a microscope light. The information-processing apparatus may be provided in the light-emitting apparatus.

Furthermore, the display apparatus may be any kind of apparatus as long as the apparatus displays an image on a screen by modulating light emitted from the light-emitting apparatus. For example, the display apparatus may be a transmission liquid crystal display apparatus, a reflection liquid crystal display apparatus, or the like. The display apparatus may be a micro electro mechanical system (MEMS) shutter system display apparatus which uses a MEMS shutter instead of liquid crystal elements. The display apparatus may be an advertisement display apparatus, a traffic sign display apparatus, or the like. The display apparatus may be a color display apparatus (a display apparatus capable of displaying color images) or a monochromatic display apparatus (a display apparatus only capable of displaying monochromatic images).

### Problem

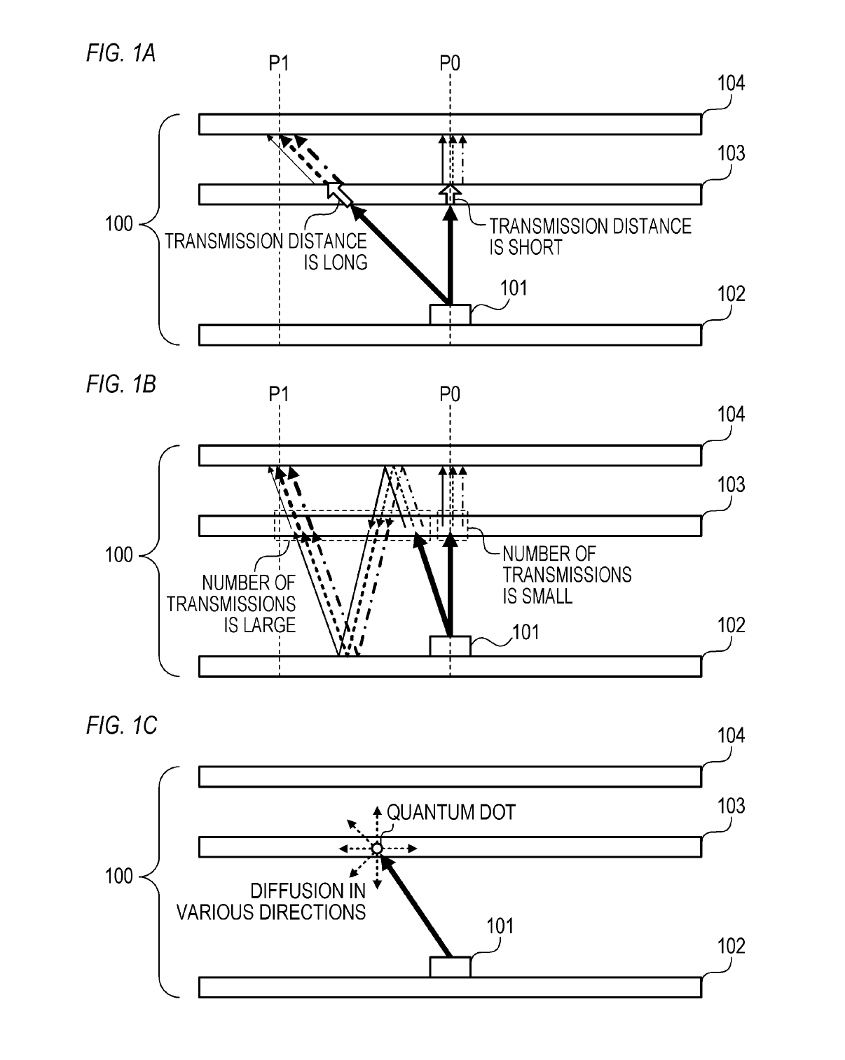

A specific example of a problem solved in the present embodiment will now be described. FIGS. 1A to 1C show an example of a cross section of a light-emitting apparatus 100 according to the present embodiment. The light-emitting apparatus 100 includes a plurality of light source units and a converting member (a wavelength converting member). The converting member converts a wavelength of light emitted from the plurality of light source units.

In the example shown in FIGS. 1A to 1C, as a light source unit, the light-emitting apparatus 100 includes a B-LED 101 which is a light-emitting diode (LED) that emits blue light. The B-LED 101 is provided on a reflective plate (a substrate) 102. The light-emitting apparatus 100 includes a quantum dot sheet 103 as a converting member. The quantum dot sheet 103 is a sheet-like member containing a plurality of R quantum dots and a plurality of G quantum dots. The R quantum dot is a quantum dot that emits red light due to excitation caused by blue light. The G quantum dot is a quantum dot that emits green light due to excitation caused by blue light.

In the light-emitting apparatus 100, a part of blue light emitted from the B-LED 101 is converted into red light by the R quantum dots and the red light is emitted from the quantum dot sheet 103. In addition, a part of the blue light emitted from the B-LED 101 is converted into green light by the G quantum dots and the green light is emitted from the quantum dot sheet 103. Furthermore, a part of the blue light emitted from the B-LED 101 is emitted from the quantum dot sheet 103 without being converted thereby. The light (light including red light, green light, and blue light) emitted from the quantum dot sheet 103 irradiates an optical member 104.

The optical member 104 imparts an optical variance to incident light and emits light after being imparted with the optical variance. The optical member 104 is a diffuser plate, a diffuser sheet, a brightness enhancement film (BEF), a dual brightness enhancement film (DBEF), or the like.

In a case where light is emitted from the light-emitting apparatus 100, light from the B-LED 101 is reflected by the reflective plate 102, the quantum dot sheet 103, the optical member 104, and the like or is transmitted through the quantum dot sheet 103, the optical member 104, and the like. However, reflection characteristics of the reflective plate 102, the quantum dot sheet 103, the optical member 104, and the like and transmission characteristics of the quantum dot sheet 103, the optical member 104, and the like are not uniform across all frequency bands of light. Therefore, spectral characteristics of light from the B-LED 101 vary every time the light is reflected and vary every time the light is transmitted. In particular, the spectral characteristics of light from the B-LED 101 vary significantly at the quantum dot sheet 103. In addition, a magnitude of the variance in spectral characteristics at the quantum dot sheet 103 varies depending on a distance (a transmission distance) that the light from the B-LED 101 travels when being transmitted through the quantum dot sheet 103, the number of times (the number of collisions) the light from the B-LED 101 strikes a quantum dot, and the like.

For example, as shown in FIG. 1A, at a position P1 away from the B-LED 101, the transmission distance is longer and the number of collisions is larger as compared to a position P0 directly above the B-LED 101. Therefore, at the position P1, a larger amount of blue light is converted into red light and green light as compared to the position P0. As a result, at the position P1, the color of light emitted from the light-emitting apparatus 100 approaches yellow more closely than at the position P0. Due to the color of light emitted from the light-emitting apparatus approaching yellow, brightness of the light emitted from the light-emitting apparatus also increases. Moreover, in FIGS. 1A to 1C, solid arrows represent blue light, dashed arrows represent green light, and dashed-dotted arrows represent red light. In addition, a width of each arrow indicates an amount of light corresponding to the arrow.

Furthermore, as shown in FIG. 1B, at the position P1, the light emitted from the light-emitting apparatus 100 includes light of which the number of times (the number of transmissions) the blue light from the B-LED 101 is transmitted through the quantum dot sheet 103 is larger as compared to the position P0. Every time the blue light from the B-LED 101 is transmitted through the quantum dot sheet 103, a part of the blue light is converted into red light and green light. As a result, at the position P1, the color of light emitted from the light-emitting apparatus 100 approaches yellow more closely than at the position P0.

In addition, as shown in FIG. 1C, light (red light, green light, and the like) obtained by a quantum dot is diffused in various directions from the quantum dot. Accordingly, since red light and green light included in the light emitted from the light-emitting apparatus 100 increase, the color of light emitted from the light-emitting apparatus 100 is made to approach yellow.

A case will now be considered where a plurality of B-LEDs 101 respectively correspond to a plurality of divided light emission areas constituting a light emission surface of the light-emitting apparatus 100 and emission brightness (emission intensity) of the plurality of B-LEDs 101 is individually controlled. Such control is referred to as “local dimming control”. In a case where the light-emitting apparatus 100 is used in a display apparatus, a plurality of divided display areas constituting a screen of the display apparatus may be used in place of the plurality of divided light emission areas. Blue light emitted from the B-LED 101 corresponding to a certain divided light emission area leaks into another divided light emission area. Hereafter, light having leaked into another divided light emission area will be described as “leakage light”. Due to various factors including the variance in spectral characteristics described above (for example, the variance described with reference to FIGS. 1A to 1C), the color of light emitted from the light-emitting apparatus 100 varies depending on a light emission pattern of the light-emitting apparatus 100. For example, the color of light emitted from the light-emitting apparatus 100 varies depending on leakage light.

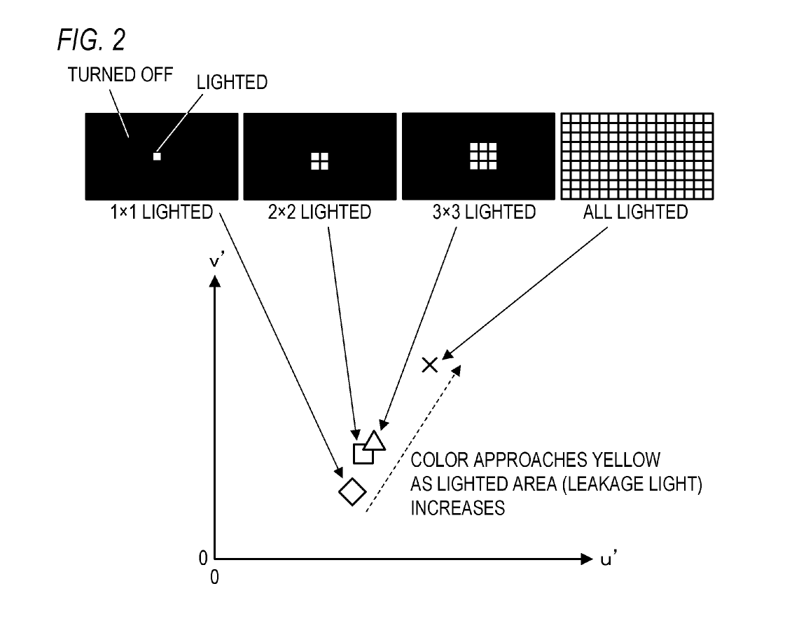

FIG. 2 shows an example of a correspondence relationship between the light emission pattern of the light-emitting apparatus 100 and the color of light emitted from the light-emitting apparatus 100. FIG. 2 shows an example using 144 B-LEDs 101 respectively corresponding to 144 divided light emission areas arranged in a 9-row, 16-column matrix pattern. In FIG. 2, as the color of light emitted from the light-emitting apparatus 100 at a center of the light emission surface, four colors respectively corresponding to four light emission patterns described below are plotted on a u′v′ color space. In the four light emission patterns described below, emission brightness of the lighted B-LED 101 is constant (prescribed reference brightness). Therefore, the larger a lighting area (the number of lighted B-LEDs 101), the larger an amount of leakage light to the center of the light emission surface. FIG. 2 shows that the color of the light emitted from the light-emitting apparatus 100 varies depending on a variance in the light emission pattern. Specifically, it is shown that, in accordance with an increase in the lighting area (leakage light), the color of the light emitted from the light-emitting apparatus 100 more closely approaches yellow.

A light emission pattern in which a single B-LED 101 near the center of the light emission surface emits light at reference brightness and, at the same time, remaining B-LEDs 101 are turned off (central singular light emission pattern)

A light emission pattern in which four B-LEDs 101 in a 2-row, 2-column arrangement near the center of the light emission surface emit light at reference brightness and, at the same time, the remaining B-LEDs 101 are turned off

A light emission pattern in which nine B-LEDs 101 in a 3-row, 3-column arrangement near the center of the light emission surface emit light at reference brightness and, at the same time, the remaining B-LEDs 101 are turned off

A light emission pattern in which all B-LEDs 101 emit light at reference brightness

A distribution of light emitted from the light-emitting apparatus 100 may be estimated for various purposes. For example, in a case where the light-emitting apparatus 100 is used in a display apparatus, the distribution of the light emitted from the light-emitting apparatus 100 may be estimated in order to reduce brightness non-uniformity of a display image (an image displayed on a screen), color non-uniformity of the display image, and the like.

As a conventional estimation method, a method using profile data indicating a distribution of light emitted from a single B-LED 101 and emitted from the light-emitting apparatus 100 is proposed. Specifically, by multiplying each value of a distribution indicated by profile data by a gain value in accordance with emission brightness of the B-LED 101, a distribution of light emitted from the B-LED 101 and emitted from the light-emitting apparatus 100 is estimated. This process is performed for each of a plurality of B-LEDs 101. In addition, by compositing a plurality of obtained distributions, a distribution of light emitted from the light-emitting apparatus 100 is estimated.

However, due to various factors, a shape of a distribution of light emitted from a (single) B-LED 101 and emitted from the light-emitting apparatus 100 varies depending on the light emission pattern of the light-emitting apparatus 100. The various factors include the variance in spectral characteristics described earlier (for example, the variance described with reference to FIGS. 1A to 1C). In addition, in the estimation method described above, the variance in the shape (such as a spread) of the distribution described earlier is not reflected in a result of the estimation. Therefore, with the estimated method described above, the distribution of light emitted from the light-emitting apparatus 100 cannot be estimated with high accuracy.

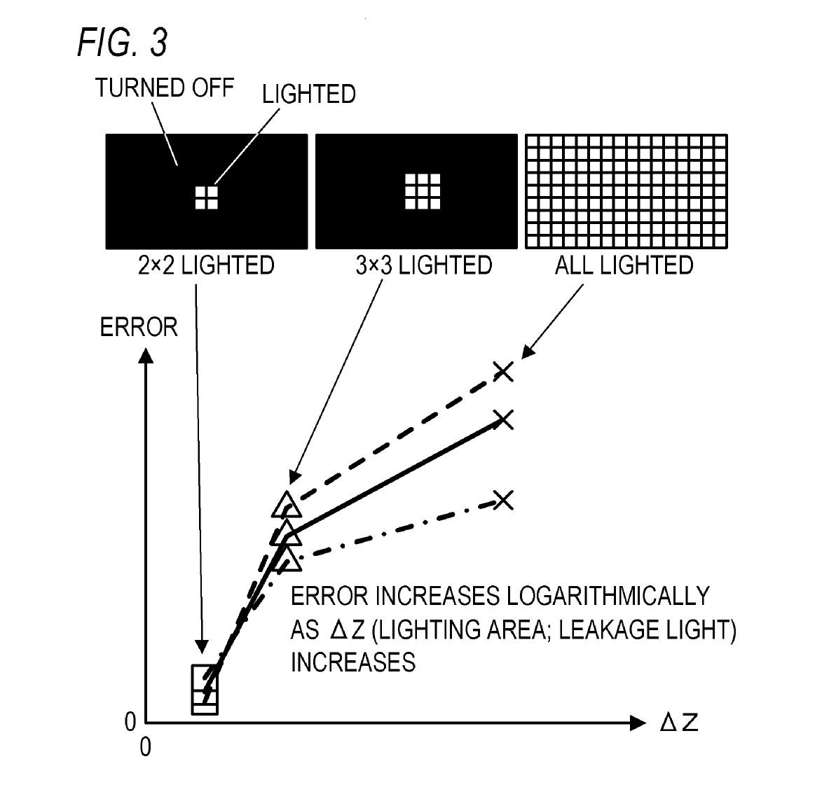

FIG. 3 shows an example of an error in a value (estimated value) that is estimated in the estimation method described above. In FIG. 3, as an error in an estimated value of light emitted from the light-emitting apparatus 100 at the center of the light emission surface, errors in three light emission patterns described below are shown. A horizontal axis in FIG. 3 represents a difference ΔZ obtained by subtracting, from a Z value (a Z value of XYZ tristimulus values) estimated with respect to a corresponding light emission pattern, a Z value estimated with respect to a central singular light emission pattern. The difference ΔZ is also a value estimated as a Z value of leakage light to the center of the light emission surface. A vertical axis in FIG. 3 represents a difference (an error) between an estimated value and a measurement value. A solid line in FIG. 3 represents an error of an estimated X value (an X value of XYZ tristimulus values), a dashed line in FIG. 3 represents an error of an estimated Y value (a Y value of XYZ tristimulus values), and a dashed-dotted line in FIG. 3 represents an error of an estimated Z value. FIG. 3 shows that the error varies in accordance with a variance in the light emission pattern. Specifically, it is shown that, as the difference ΔZ (lighting area; leakage light) increases, the error increases logarithmically. A variance in the error due to a variance in the light emission pattern is also a variance in the shape of the distribution of light emitted from the B-LED 101 and emitted from the light-emitting apparatus 100 which is dependent on the light emission pattern of the light-emitting apparatus 100.

A light emission pattern in which four B-LEDs 101 in a 2-row, 2-column arrangement near the center of the light emission surface emit light at reference brightness and, at the same time, remaining B-LEDs 101 are turned off

A light emission pattern in which nine B-LEDs 101 in a 3-row, 3-column arrangement near the center of the light emission surface emit light at reference brightness and, at the same time, the remaining B-LEDs 101 are turned off

A light emission pattern in which all B-LEDs 101 emit light at reference brightness

As shown, with the estimated method described above, the distribution of light emitted from the light-emitting apparatus 100 cannot be estimated with high accuracy. In addition, even with other conventional estimation methods, the variance in the shape of the distribution described earlier is not reflected in a result of estimation. Therefore, with other conventional estimation methods, the distribution of light emitted from the light-emitting apparatus 100 cannot be estimated with high accuracy.

Moreover, a configuration of a light-emitting apparatus is not limited to the configuration described above. For example, one light source unit may include a plurality of light-emitting elements. Light-emitting elements are not limited to LEDs. For example, as a light-emitting element, an organic EL element, a semiconductor laser, a plasma element, a cold cathode fluorescent tube (CCFL), and the like may be used. Light emitted from the light source unit is not limited to blue light. For example, light including ultraviolet light (including near-ultraviolet light) may be emitted from the light source unit. Light including light other than blue light and ultraviolet light may be emitted from the light source unit. Conversion characteristics (a wavelength before conversion, a wavelength after conversion, and the like) of a converting member are not particularly limited. The converting member may include a phosphor that differs from a quantum dot. An arrangement of the light source unit, the number of light source units, an arrangement of divided light emission areas, the number of divided light emission areas, and the like are also not particularly limited. For example, a plurality of light source units may be arranged in a staggered pattern. The number of the light source units may be larger or smaller than 144.

In addition, in a case where the shape of a distribution of light emitted from (one) light source unit and emitted from a light-emitting apparatus varies depending on a light emission pattern of the light-emitting apparatus, the problem described above arises regardless of a type of the light-emitting apparatus. For example, in a case where the shape of the distribution of light emitted from a light source unit and emitted from a light-emitting apparatus varies depending on a light emission pattern of the light-emitting apparatus, the problem described above arises even when the light-emitting apparatus does not involve a converting member.

Configuration of Display Apparatus

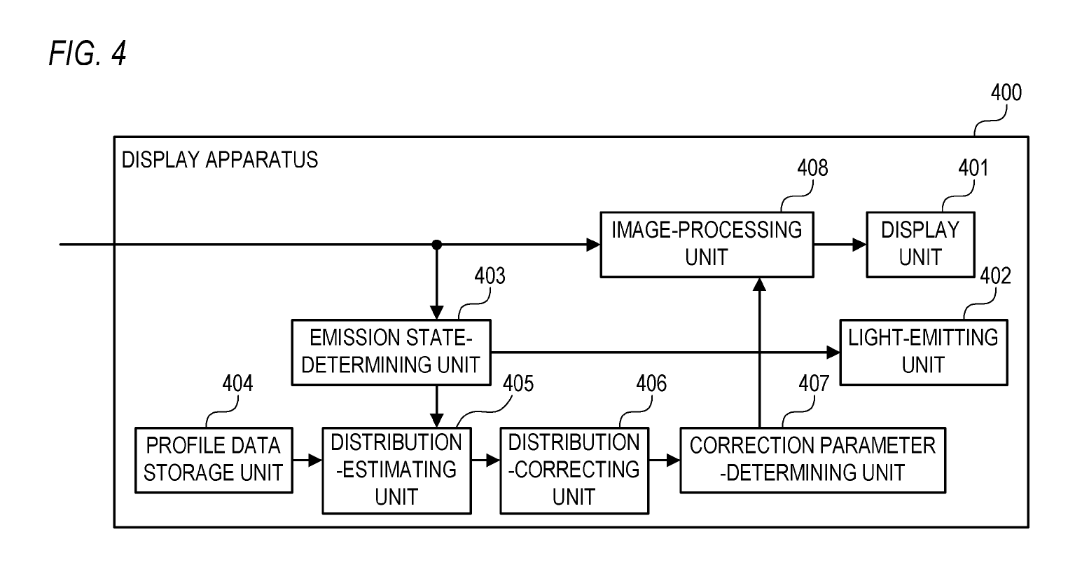

A configuration example of a display apparatus according to the present embodiment will be described. FIG. 4 shows a configuration example of a display apparatus 400 according to the present embodiment. The display apparatus 400 includes a display unit 401, a light-emitting unit 402, an emission state-determining unit 403, a profile data storage unit 404, a distribution-estimating unit 405, a distribution-correcting unit 406, a correction parameter-determining unit 407, and an image-processing unit 408.

The display unit 401 displays an image by modulating (transmitting, reflecting, or the like), based on input image data, light emitted from the light-emitting unit 402. In the present embodiment, display image data is generated from input image data by the image-processing unit 408. In addition, the display unit 401 displays an image by modulating, based on display image data output from the image-processing unit 408, light from the light-emitting unit 402. For example, the display unit 401 is a liquid crystal panel.

The light-emitting unit 402 irradiates the display unit 401 with light. The light-emitting unit 402 includes a plurality of light source units. For example, the light-emitting unit 402 is the light-emitting apparatus 100 shown in FIGS. 1A to 1C. In the present embodiment, a plurality of divided display areas constituting a screen area are respectively associated with a plurality of light source units as a plurality of light emission control areas for controlling an emission state (emission brightness, emission color, and the like) of a light source unit. The plurality of divided display areas are also used as a plurality of estimation areas (partial areas) for obtaining information representing a distribution of light emitted from the light-emitting unit 402. In a transmission liquid crystal display device or the like, the light-emitting unit 402 is also referred to as a “backlight apparatus”, a “backlight unit”, or the like.

Moreover, the light emission control area is not limited to a divided display area. For example, the light emission control area may be separated from other light emission control areas or at least a part of the light emission control area may overlap with at least a part of another light emission control area. Two or more light source units may be associated with one light emission control area. The light emission control area may constitute a part of an area of a screen or may constitute an entirety of the area of a screen.

In addition, an estimation area is not limited to a divided display area. For example, the estimation area may be an area constituting a part of the light emission surface of the light-emitting unit 402. The estimation area may be separated from other estimation areas. Two or more estimation areas may be associated with one light source unit.

In the present embodiment, an emission state of each light source unit is controlled in accordance with an emission control value bd output from the emission state-determining unit 403. Specifically, the emission control value bd corresponds to emission brightness (emission intensity) of a light source unit. In addition, the emission brightness of the light source unit is controlled in accordance with the emission control value bd. Moreover, the light source unit may be configured such that an emission color is variable. Furthermore, the emission color of the light source unit may be controlled in accordance with the emission control value bd. One of the emission brightness of the light source unit and the emission color of the light source unit may be controlled in accordance with the emission control value bd. Both the emission brightness of the light source unit and the emission color of the light source unit may be controlled in accordance with the emission control value bd.

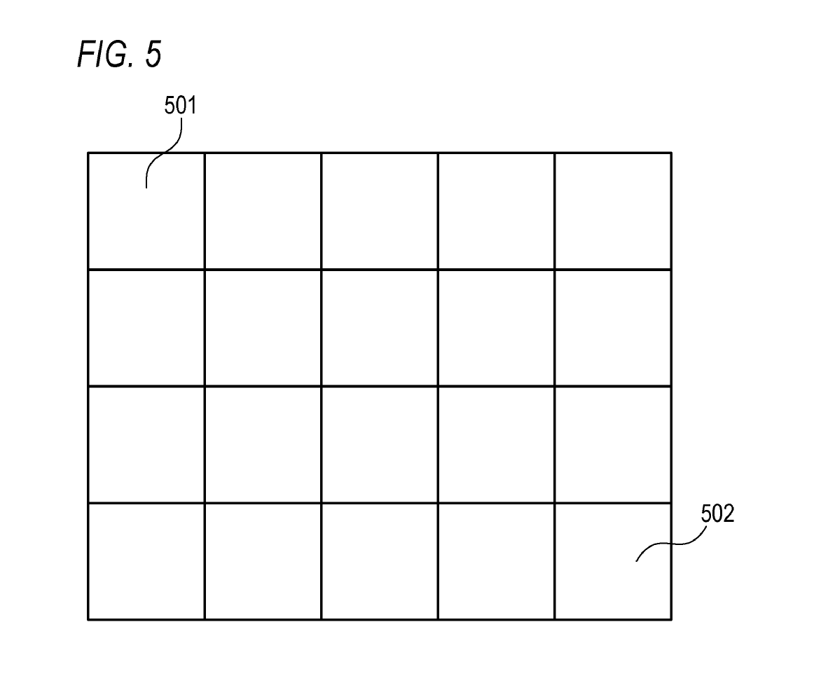

In the present embodiment, a plurality of divided display areas are arranged in a matrix pattern. FIG. 5 is a schematic diagram showing an example of a plurality of divided display areas. In the example shown in FIG. 5, a screen is constituted by 20 divided display areas in a 4-row, 5-column arrangement. In the present embodiment, the emission control value bd of a light source unit corresponding to an mth-row, nth-column divided display area will be described as an “emission control value bdmn”. For example, the emission control value bd of a light source unit corresponding to a 1st-row, 1st-column divided display area 501 is an emission control value bd11, and the emission control value bd of a light source unit corresponding to a 4th-row, 5th-column divided display area 502 is an emission control value bd45.

The emission state-determining unit 403 individually controls an emission state of each of a plurality of light source units based on input image data. In the present embodiment, for each of a plurality of divided display areas, the emission state-determining unit 403 determines the emission control value bd for controlling emission brightness of a light source unit corresponding to the divided display area based on input image data with respect to the divided display area. In addition, the emission state-determining unit 403 outputs a plurality of emission control values bd respectively corresponding to the plurality of light source units to the light-emitting unit 402. The emission state-determining unit 403 also outputs the plurality of emission control values bd to the distribution-estimating unit 405.

The profile data storage unit 404 records, in advance, profile data related to an estimated reference distribution that is a distribution of light emitted from the light-emitting unit 402 in a case where a light emission pattern of the light-emitting unit 402 is controlled to a reference light emission pattern. The reference light emission pattern is a light emission pattern in which a corresponding light source unit among a plurality of light source units emits light at reference brightness and, at the same time, all of the remaining light source units are turned off. Profile data is used for each of the plurality of light source units. In the present embodiment, profile data related to both a brightness distribution and a color distribution is recorded in advance in the profile data storage unit 404. Specifically, X profile data related to a distribution of X values, Y profile data related to a distribution of Y values, and Z profile data related to a distribution of Z values are recorded in advance in the profile data storage unit 404. As the profile data storage unit 404, a magnetic disk, an optical disk, a semiconductor memory, or the like can be used. The profile data storage unit 404 may be built into an apparatus (a display apparatus, a light-emitting apparatus, or an information-processing apparatus) or may be attachable to and detachable from the apparatus.

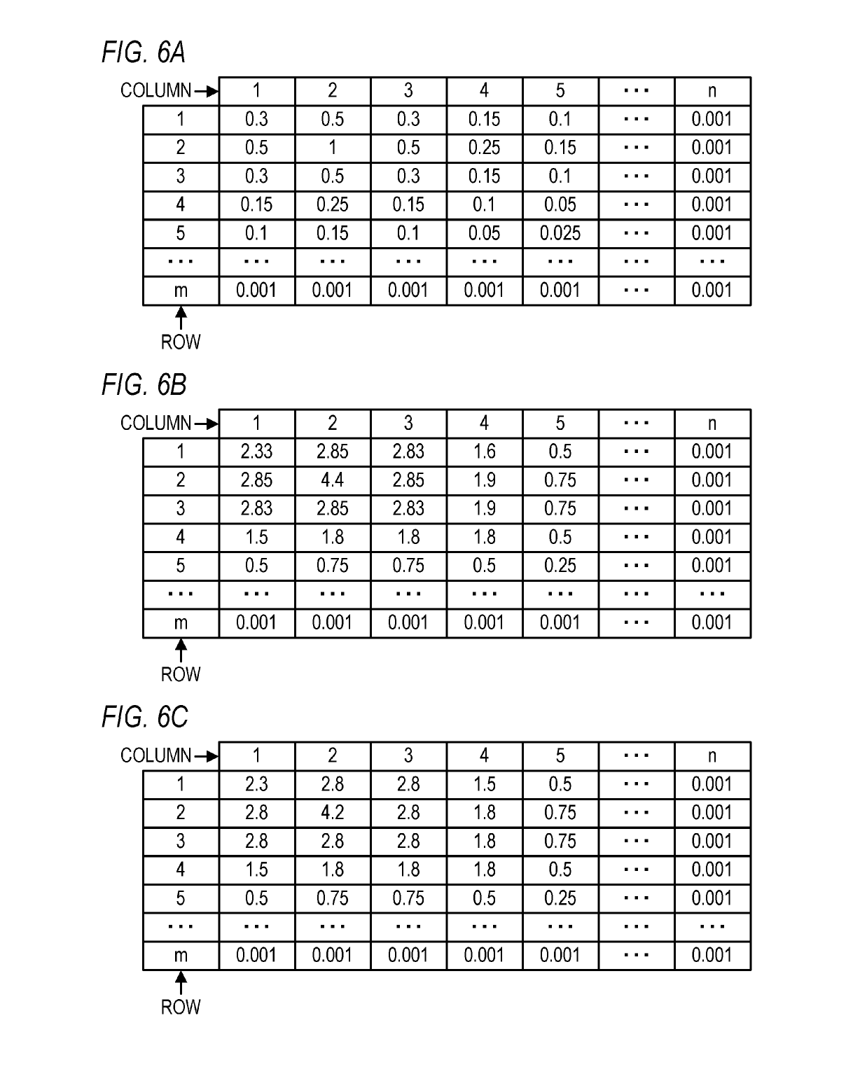

In the present embodiment, X profile data indicates, for each of a plurality of divided display areas, an X value FX normalized so that a maximum value of X values is 1. Y profile data indicates, for each of a plurality of divided display areas, a Y value FY normalized so that a maximum value of X values is 1. Z profile data indicates, for each of a plurality of divided display areas, a Z value FZ normalized so that a maximum value of X values is 1. FIG. 6A shows an example of a distribution of X values FX, FIG. 6B shows an example of a distribution of Y values FY, and FIG. 6C shows an example of a distribution of Z values FZ. FIGS. 6A to 6C show examples in which a corresponding light source unit is a light source unit corresponding to a 2nd-row, 2nd-column divided display area. Light emitted from a light source unit attenuates as the light recedes from the light source unit. Therefore, in FIGS. 6A to 6C, the X value FX, the Y value FY, and the Z value FZ take maximum values in the 2nd-row, 2nd-column divided display area. In addition, as a distance from the 2nd-row, 2nd-column divided display area increases, the X value FX, the Y value FY, and the Z value FZ decrease. In the present embodiment, in a case where a light source unit corresponding to an mth-row, nth-column divided display area is a corresponding light source unit, the X value FX of an m′th-row, n′th-column divided display area will be described as an “X value FXmnm′n′”. In a similar manner, the Y value FY of the m′th-row, n′th-column divided display area will be described as a “Y value FYmnm′n′” and the Z value FZ of the m′th-row, n′th-column divided display area will be described as a “Z value FZmnm′n′”.

Moreover, a plurality of pieces of profile data respectively corresponding to a plurality of light source units may or may not be recorded in advance. Profile data corresponding to a light source unit is profile data in a case where the light source unit is a corresponding light source unit. The number of pieces of profile data may be smaller than the number of light source units. For example, one piece of profile data may be recorded in advance. Two or more pieces of profile data, of which the number of pieces is smaller than the number of light source units, may be recorded in advance. In a case where the number of pieces of profile data is smaller than the number of light source units, for example, one piece of profile data serves as two or more pieces of profile data respectively corresponding to two or more light source units. A shape of an estimated reference distribution does not vary significantly even when a corresponding light source unit varies among a plurality of light source units. Therefore, by varying a position of one estimated reference distribution, two or more pieces of profile data respectively corresponding to two or more light source units can be obtained from one piece of profile data.

In addition, the reference light emission pattern is not limited to the light emission pattern described above. For example, in the reference light emission pattern, a light source unit at a large distance from a corresponding light source unit may be lighted. The profile data is not limited to the profile data shown in FIGS. 6A to 6C. The profile data may be any kind of data as long as the data is related to an estimated reference distribution. The estimated reference distribution is not limited to a distribution of XYZ tristimulus values. The estimated reference distribution may be a distribution of RGB values, a distribution of YCbCr values, a brightness distribution, a color distribution, or the like. The estimated reference distribution may include only one of a brightness distribution and a color distribution. The estimated reference distribution may or may not include a plurality of distributions having mutually different types of values.

The distribution-estimating unit 405 acquires, from the profile data storage unit 404, profile data recorded in advance in the profile data storage unit 404. In addition, the distribution-estimating unit 405 estimates a displayed light emission distribution based on the acquired profile data and a displayed light emission pattern. The displayed light emission distribution is a distribution of light emitted from the light-emitting unit 402 in a case where a light emission pattern of the light-emitting unit 402 is controlled to a displayed light emission pattern. The displayed light emission pattern is a light emission pattern in a case where an emission state of each of a plurality of light source units is individually controlled based on input image data. In the present embodiment, the displayed light emission pattern is a light emission pattern in a case where an emission state of each light source unit is controlled in accordance with the emission control value bd determined by the emission state-determining unit 403. In the present embodiment, the distribution-estimating unit 405 estimates a displayed light emission distribution based on the profile data recorded in advance in the profile data storage unit 404 and the emission control value bd output from the emission state-determining unit 403. The distribution-estimating unit 405 outputs an estimation result of the displayed light emission distribution to the distribution-correcting unit 406. Hereinafter, an estimated displayed light emission distribution will be described as an “estimated light emission distribution”.

Moreover, the displayed light emission pattern is not limited to the light emission pattern described above. For example, the displayed light emission pattern may be a light emission pattern in accordance with an operation performed by a user on an apparatus (a display apparatus, a light-emitting apparatus, or an information-processing apparatus).

In the present embodiment, a distribution including both a brightness distribution and a color distribution is obtained as the estimated light emission distribution. Specifically, a distribution of XYZ tristimulus values is obtained as the estimated light emission distribution. Moreover, the estimated light emission distribution is not limited to a distribution of XYZ tristimulus values. The estimated light emission distribution may be a distribution of RGB values, a distribution of YCbCr values, a brightness distribution, a color distribution, or the like. The estimated light emission distribution may include only one of a brightness distribution and a color distribution. The estimated light emission distribution may or may not include a plurality of distributions having mutually different types of values.

The distribution-correcting unit 406 corrects an estimated light emission distribution output from the distribution-estimating unit 405 based on values of the estimated light emission distribution, the profile data recorded in advance in the profile data storage unit 404, and the displayed light emission pattern. In the present embodiment, the estimated light emission distribution is corrected to as to reflect a variance in a shape of a distribution of light emitted from a light source unit and emitted from the light-emitting unit 402 which is a variance attributable to a variance in the light emission pattern of the light-emitting unit 402. The distribution-correcting unit 406 outputs a correction result of the estimated light emission distribution to the correction parameter-determining unit 407. Hereinafter, an estimated light emission distribution after correction will be described as a “corrected light emission distribution”.

While a correction method of an estimated light emission distribution is not particularly limited, in a case where the estimated light emission distribution includes a plurality of distributions having mutually different types of values, each of the plurality of distributions is favorably corrected using any of the values of the plurality of distributions. For example, in a case where the estimated light emission distribution includes a distribution of X values, a distribution of Y values, and a distribution of Z values, each of the plurality of distributions is favorably corrected using the X value, the Y value, or the Z value. Accordingly, since each of the plurality of distributions is corrected based on a same reference, an improvement in correction accuracy can be expected. In addition, since only one reference needs to be determined, a processing load due to correction can be reduced.

A case where the light-emitting unit 402 is the light-emitting apparatus 100 shown in FIGS. 1A to 1C will now be considered. In this case, a wavelength of blue light emitted from a light source unit (the B-LED 101) is converted by a converting member (the quantum dot sheet 103). Specifically, excitation of a quantum dot is caused by the blue light. In addition, the Z value is approximately equivalent to intensity of the blue light while the X value and the Y value are approximately equivalent to intensity of other light (light after wavelength conversion; light created due to the excitation). Therefore, a correlation between the Z value of the estimated light emission distribution and the X value of the estimated light emission distribution and a correlation between the Z value of the estimated light emission distribution and the Y value of the estimated light emission distribution are stronger than a correlation between the X value of the estimated light emission distribution and the Y value of the estimated light emission distribution. From this perspective, in a case where the estimated light emission distribution includes a distribution of Z values, each of the plurality of distributions included in the estimated light emission distribution is favorably corrected using the Z value. Accordingly, the estimated light emission distribution can be corrected with high accuracy as compared to cases where the X value, the Y value, or the like are used.

In the present embodiment, a distribution including both a brightness distribution and a color distribution is obtained as the corrected light emission distribution. Specifically, a distribution of XYZ tristimulus values is obtained as the corrected light emission distribution. Moreover, the corrected light emission distribution is not limited to a distribution of XYZ tristimulus values. The corrected light emission distribution may be a distribution of RGB values, a distribution of YCbCr values, a brightness distribution, a color distribution, or the like. The corrected light emission distribution may include only one of a brightness distribution and a color distribution. The corrected light emission distribution may or may not include a plurality of distributions having mutually different types of values.

The correction parameter-determining unit 407 determines a correction parameter for correcting input image data based on the corrected light emission distribution obtained by the distribution-correcting unit 406. The correction parameter is a parameter for suppressing a variance in display (brightness of a display image, color of a display image, and the like) due to a variance of the distribution of the light emitted from the light-emitting unit 402 from a corrected reference distribution. The corrected reference distribution is a distribution in a case where emission brightness of each of a plurality of light source units is controlled to upper limit brightness. In the present embodiment, as the correction parameter, a gain value is determined by which XYZ tristimulus values obtained from the input image data are to be multiplied. The correction parameter-determining unit 407 outputs the determined correction parameter to the image-processing unit 408.

Moreover, the correction parameter is not limited to the gain value described above. For example, the correction parameter may be a gain value by which RGB values obtained from the input image data are to be multiplied, a gain value by which YCbCr values obtained from the input image data are to be multiplied, or the like. The correction parameter may be an offset value to be added to values (XYZ tristimulus values, RGB values, YCbCr values, or the like) obtained from the input image data. In addition, the corrected reference distribution is not limited to the distribution described above. For example, the corrected reference distribution may be modified in accordance with the input image data. An upper limit brightness of a light source unit may be modified in accordance with the input image data. The reference brightness described earlier may or may not be the upper limit brightness of a light source unit.

In addition, the correction parameter is not limited to a parameter for correcting input image data. For example, a parameter for correcting a displayed light emission pattern may be determined as the correction parameter. Specifically, a parameter for correcting an emission state (an emission state corresponding to a displayed light emission pattern) of each of a plurality of light source units so that a distribution of light emitted from the light-emitting unit 402 becomes a desired distribution may be determined as the correction parameter. A parameter for correcting both input image data and a displayed light emission pattern may be determined as the correction parameter or a parameter for correcting one of the input image data and the displayed light emission pattern may be determined as the correction parameter. For example, a parameter for correcting at least one of the input image data and the displayed light emission pattern so that desired display is realized may be determined as the correction parameter.

The image-processing unit 408 generates display image data by correcting input image data based on the correction parameter output from the correction parameter-determining unit 407. In the present embodiment, a pixel value of the input image data is RGB values. In addition, as described above, the correction parameter is a gain value by which XYZ tristimulus values are to be multiplied. The image-processing unit 408 transforms each pixel value of the input image data from RGB values into XYZ tristimulus values, and multiplies the respective obtained XYZ tristimulus values with the correction parameter (the gain value). In addition, the image-processing unit 408 retransforms the respective XYZ tristimulus values after being multiplied with the correction parameter into RGB values. As a result, display image data is generated. The image-processing unit 408 outputs the display image data to the display unit 401.

Moreover, in the image-processing unit 408, other image processing such as a brightness conversion process, a color conversion process, a resolution conversion process, a blurring process, an edge enhancement process, a frame rate conversion process, and an I/P conversion process may be performed. A data format of the input image data, a correction method of the input image data, and the like are not particularly limited. For example, a pixel value of the input image data may be YCbCr values, XYZ tristimulus values, or the like. The pixel value of the input image data may not be transformed and the correction parameter may be transformed so that a data format of the correction parameter matches a data format of the input image data. Subsequently, the pixel value of the input image data may be corrected using the transformed correction parameter. For example, the pixel value of the input image data may not be transformed from RGB values into XYZ tristimulus values while a gain value by which XYZ tristimulus values are to be multiplied may be transformed into a gain value by which RGB values are to be multiplied. Subsequently, the RGB values of the input image data may be multiplied with the transformed gain value. In a case where the data format of the correction parameter matches the data format of the input image data to begin with, the transformation of the pixel value of the input image data, the transformation of the correction parameter, and the like are to be omitted.

Determination Method of Emission Control Value bd

A specific example of a determination method of the emission control value bd according to the present embodiment will be described.

Step 1-1

First, the emission state-determining unit 403 transforms each pixel value of input image data into a brightness value Y. For example, in a case where the pixel value of the input image data is RGB values (R value, G value, B value)=(R, G, B), the emission state-determining unit 403 calculates the brightness value Y using expression 1 below. In expression 1, “α”, “β”, and “γ” are prescribed coefficients (brightness conversion coefficients) for transforming RGB values into a Y value.

Y=α×R+β×G+γ×B (Expression 1)

Step 1-2

Next, for each of a plurality of divided display areas, the emission state-determining unit 403 calculates an average value (an average brightness value) Ya of a plurality of brightness values Y in the divided display area. In the present embodiment, the average brightness value Ya corresponding to an mth-row, nth-column divided display area will be described as an “average brightness value Yamn”.

Step 1-3

In addition, for each of the plurality of divided display areas, the emission state-determining unit 403 determines the emission control value bd of a light source unit corresponding to the divided display area in accordance with the average brightness value Ya corresponding to the divided display area. In the present embodiment, the emission state-determining unit 403 calculates the emission control value bdmn using expression 2 below. In expression 2, “Ymax” denotes an upper limit value of the brightness value Y. In the present embodiment, the emission control value bd is a value ranging from 0 to 1 and, the higher the emission brightness, the larger the value.

bdmn=Yamn÷Ymax (Expression 2)

Moreover, the emission control value bd is not limited to the value described above. For example, a range of the emission control value bd may be wider or narrower than from 0 to 1. The emission control value bd may be a value such that, the higher the emission brightness, the smaller the value. Moreover, the method of determining the emission control value bd is not limited to the method described above. For example, the emission control value bd may be determined using other characteristic values of the input image data. As other characteristic values, a maximum value of the brightness values Y, a minimum value of the brightness values Y, an intermediate value of the brightness values Y, a mode of the brightness values Y, a histogram of the brightness values Y, and the like can be used. An average value, a maximum value, a minimum value, an intermediate value, and a mode may be described as “representative values”. As other characteristic values, a representative value of a pixel value (or a gradation value) that differs from the brightness value Y, a histogram of a pixel value that differs from the brightness value Y, and the like can also be used. As the determination method of the emission control value bd, various proposed methods can be used.

Acquisition Method of Estimated Light Emission Distribution

A specific example of an acquisition method of an estimated light emission distribution according to the present embodiment will be described.

Step 2-1

First, for each of a plurality of light source units, the distribution-estimating unit 405 estimates a singular light emission distribution based on a displayed light emission pattern and the profile data recorded in advance in the profile data storage unit 404. The singular light emission distribution that is estimated with respect to a light source unit is a distribution of light emitted from the light-emitting unit 402 in a case where a light emission pattern of the light-emitting unit 402 is controlled to a singular light emission pattern corresponding to the light source unit. The singular light emission pattern is a light emission pattern in which an emission state of a light source unit corresponding to the singular light emission pattern is controlled to an emission state corresponding to the displayed light emission pattern and, at the same time, all remaining light source units are turned off. In the present embodiment, the singular light emission pattern is a light emission pattern in which the emission state of the light source unit corresponding to the singular light emission pattern is controlled based on the input image data and, at the same time, all remaining light source units are turned off. Specifically, the singular light emission pattern is a light emission pattern in which emission brightness of the light source unit corresponding to the singular light emission pattern is controlled in accordance with the emission control value bd and, at the same time, all remaining light source units are turned off. In the present embodiment, the distribution-estimating unit 405 estimates the singular light emission distribution based on the profile data recorded in advance in the profile data storage unit 404 and the emission control value bd output from the emission state-determining unit 403. Hereinafter, an estimated singular light emission distribution will be described as an “estimated singular light emission distribution”.

Moreover, the singular light emission pattern is not limited to the light emission pattern described above. For example, in the singular light emission pattern, a light source unit at a large distance from a light source unit corresponding to the singular light emission pattern may be lighted.

In the present embodiment, a distribution including both a brightness distribution and a color distribution is obtained as the estimated singular light emission distribution. Specifically, a distribution of XYZ tristimulus values is obtained as the estimated singular light emission distribution. Moreover, the estimated singular light emission distribution is not limited to a distribution of XYZ tristimulus values. The estimated singular light emission distribution may be a distribution of RGB values, a distribution of YCbCr values, a brightness distribution, a color distribution, or the like. The estimated singular light emission distribution may include only one of a brightness distribution and a color distribution. The estimated singular light emission distribution may or may not include a plurality of distributions having mutually different types of values.

In the present embodiment, an X value of an estimated singular light emission distribution will be described as an “X value AX”, a Y value of the estimated singular light emission distribution will be described as a “Y value AY”, and a Z value of the estimated singular light emission distribution will be described as a “Z value AZ”. In addition, in the present embodiment, the X value AX of an m′th-row, n′th-column divided display area in an estimated singular light emission distribution obtained with respect to a light source unit corresponding to an mth-row, nth-column divided display area will be described as an “X value AXmnm′n′”. In a similar manner, the Y value AY of the m′th-row, n′th-column divided display area will be described as a “Y value AYmnm′n′” and the Z value AZ of the m′th-row, n′th-column divided display area will be described as a “Z value AZmnm′n′”. In the present embodiment, the distribution-estimating unit 405 calculates the X value AXmnm′n′, the Y value AYmnm′n′, and the Z value AZmnm′n′ using expressions 3 to 5 below. By performing the calculations of expressions 3 to 5 with respect to each of a plurality of combinations of a light source unit and a divided display area, an estimated singular light emission distribution of each of a plurality of light source units can be obtained.

AXmnm′n′=FXmnm′n′×bdmn (Expression 3)

AYmnm′n′=FYmnm′n′×bdmn (Expression 4)

AZmnm′n′=FZmnm′n′×bdmn (Expression 5)

Step 2-2

Next, the distribution-estimating unit 405 extracts, for each of a plurality of estimated singular light emission distributions, an X value SX, a Y value SY, and a Z value SZ in a divided display area of a light source unit corresponding to the estimated singular light emission distribution. In the present embodiment, the X value SX extracted from the estimated singular light emission distribution of a light source unit corresponding to an mth-row, nth-column divided display area will be described as an “X value SXmn”. In a similar manner, the Y value SY extracted from the estimated singular light emission distribution of a light source unit corresponding to the mth-row, nth-column divided display area will be described as a “Y value SYmn”, and the Z value SZ extracted from the estimated singular light emission distribution of a light source unit corresponding to the mth-row, nth-column divided display area will be described as a “Z value SZmn”. In the present embodiment, the distribution-estimating unit 405 calculates the X value SXmn, the Y value SYmn, and the Z value SZmn using expressions 6 to 8 below.

SXmn=AXmnmn (Expression 6)

SYmn=AYmnmn (Expression 7)

SZmn=AZmnmn (Expression 8)

Step 2-3

In addition, the distribution-estimating unit 405 obtains an estimated light emission distribution by compositing the plurality of estimated singular light emission distributions obtained in step 2-1. In the present embodiment, an X value of an estimated light emission distribution will be described as an “X value BX”, a Y value of the estimated light emission distribution will be described as a “Y value BY”, and a Z value of the estimated light emission distribution will be described as a “Z value BZ”. In addition, in the present embodiment, the X value BX of an mth-row, nth-column divided display area will be described as an “X value BXmn”. In a similar manner, the Y value BY of the mth-row, nth-column divided display area will be described as a “Y value BYmn”, and the Z value BZ of the mth-row, nth-column divided display area will be described as a “Z value BZmn”. In the present embodiment, the distribution-estimating unit 405 calculates the X value BXmn, the Y value BYmn, and the Z value BZmn using expressions 9 to 11 below. By performing the calculations of expressions 9 to 11 with respect to each of a plurality of divided display areas, an estimated light emission distribution is obtained. Moreover, the process of step 2-3 may be performed before the process of step 2-2.

$$\begin{matrix}[ Math . 1 ] & \\ BXmn = {\sum }_{( {m}^{′} , {n}^{′} )}^{ } {AXm}^{′} {n}^{′} mn & ( Expression 9 ) \\ BYmn = {\sum }_{( {m}^{′} , {n}^{′} )}^{ } {AYm}^{′} {n}^{′} mn & ( Expression 10 ) \\ BZmn = {\sum }_{( {m}^{′} , {n}^{′} )}^{ } {AZm}^{′} {n}^{′} mn & ( Expression 11 )\end{matrix}$$

Step 2-4

Next, the distribution-estimating unit 405 outputs the plurality of X values SX, the plurality of Y values SY, and the plurality of Z values SZ obtained in step 2-2 to the distribution-correcting unit 406. In addition, the distribution-estimating unit 405 also outputs the plurality of X values BX, the plurality of Y values BY, and the plurality of Z values BZ obtained in step 2-3 to the distribution-correcting unit 406.

Moreover, each of an acquisition method of an estimated singular light emission distribution and an estimation method of an estimated light emission distribution is not particularly limited. A process of determining, as an emission state of a light source unit, one of a lighted state in which the light source unit emits light at reference brightness and a turned-off state in which the light source unit is turned off may be performed for each of a plurality of light source units. In addition, data indicating a distribution prior to normalization may be used as profile data. In this case, without performing the calculations of expressions 3 to 5, an estimated reference distribution of the profile data can be acquired as an estimated singular light emission distribution corresponding to the light source unit in the lighted state, and a distribution indicating a state without light can be acquired as an estimated singular light emission distribution corresponding to the light source unit in the turned-off state. As each of the acquisition method of an estimated singular light emission distribution and the estimation method of an estimated light emission distribution, various proposed methods can be used.

Correction Method of Estimated Light Emission Distribution

A specific example of a correction method of an estimated light emission distribution according to the present embodiment will be described. In the specific example described below, in place of a displayed light emission pattern and profile data, an X value SX, a Y value SY, and a Z value SZ obtained based on the displayed light emission pattern and the profile data are used.

Step 3-1

First, for each of a plurality of divided display areas, the distribution-correcting unit 406 calculates a difference ϵ between the Z value SZ and the Z value BZ. In the present embodiment, the difference s corresponding to an mth-row, nth-column divided display area will be described as “ϵmn”. In the present embodiment, the distribution-correcting unit 406 calculates the difference ϵmn using expression 12 below.

ϵmn=BZmn−SZmn (Expression 12)

Step 3-2

Next, for each of the plurality of divided display areas, the distribution-correcting unit 406 corrects the X value BX, the Y value BY, and the Z value BZ in accordance with the difference ϵ obtained in step 3-1. In the present embodiment, an X value obtained by correcting the X value BX will be described as an “X value KX”, a Y value obtained by correcting the Y value BY will be described as a “Y value KY”, and a Z value obtained by correcting the Z value BZ will be described as a “Z value KZ”. In addition, in the present embodiment, the X value KX of an mth-row, nth-column divided display area will be described as an “X value KXmn”. In a similar manner, the Y value KY of the mth-row, nth-column divided display area will be described as a “Y value KYmn”, and the Z value KZ of the mth-row, nth-column divided display area will be described as a “Z value KZmn”.

As described earlier, an error of an estimated value (the X value BX, the Y value BY, and the Z value BZ) increases logarithmically as the difference ϵ (the difference ΔZ) increases. Therefore, in the present embodiment, the distribution-correcting unit 406 corrects the X value BX, the Y value BY, and the Z value BZ using a correction value that varies logarithmically with respect to a variance in the difference s. Specifically, the distribution-correcting unit 406 calculates the X value KXmn, the Y value KYmn, and the Z value KZmn using expressions 13 to 15 below. In expressions 13 to 15, “qx”, “qy”, “qz”, “rx”, “ry”, and “rz” are values determined in advance based on the error described above. In addition, in expressions 13 to 15, “(100−(qx×log(ϵmn)+rx))÷100”, “(100−(qy×log(ϵmn)+ry))÷100”, and “(100−(qz×log(ϵmn)+rz))+100” represent the correction value described above.

KXmn=BXmn×(100−(qx×log(ϵmn)+rx))÷100 (Expression 13)

KYmn=BYmn×(100−(qy×log(ϵmn)+ry))÷100 (Expression 14)

KZmn=BZmn×(100−(qz×log(ϵmn)+rz))÷100 (Expression 15)

Step 3-3

In addition, the distribution-correcting unit 406 outputs the plurality of XYZ tristimulus values (KX, KY, KZ) obtained in step 3-2 to the correction parameter-determining unit 407.

Moreover, a method of correcting the estimated light emission distribution is not limited to the method described above. For example, a correction value for correcting the XYZ tristimulus values (X value, Y value, Z value)=(BX, BY, BZ) need not vary logarithmically with respect to a variance in the difference s. The correction value may be an offset value to be added to the XYZ tristimulus values (BX, BY, BZ). The XYZ tristimulus values (BX, BY, BZ) may be corrected using the Z values SZ and BZ without calculating the difference s.

Determination Method of Correction Parameter

A specific example of a determination method of the correction parameter according to the present embodiment will be described. Moreover, a determination method of the correction parameter is not limited to that described below. As the determination method of the correction parameter, various proposed methods can be used.

Step 4-1

First, with respect to each of a plurality of divided display areas, the correction parameter-determining unit 407 determines a correction parameter (a gain value) based on the XYZ tristimulus values (CX, CY, CZ) of the corrected reference distribution and the XYZ tristimulus values (KX, KY, KZ) of the corrected light emission distribution described above. In the present embodiment, the X value CX of an mth-row, nth-column divided display area will be described as an “X value CXmn”. In a similar manner, the Y value CY of the mth-row, nth-column divided display area will be described as a “Y value CYmn”, and the Z value CZ of the mth-row, nth-column divided display area will be described as a “Z value CZmn”. In addition, in the present embodiment, a correction parameter by which an X value obtained from input image data is to be multiplied will be described as a “correction parameter PX”, a correction parameter by which a Y value obtained from the input image data is to be multiplied will be described as a “correction parameter PY”, and a correction parameter by which a Z value obtained from the input image data is to be multiplied will be described as a “correction parameter PZ”. Furthermore, in the present embodiment, the correction parameter PX determined with respect to an mth-row, nth-column divided display area will be described as a “correction parameter PXmn”. In a similar manner, the correction parameter PY determined with respect to the mth-row, nth-column divided display area will be described as a “correction parameter PYmn”, and the correction parameter PZ determined with respect to the mth-row, nth-column divided display area will be described as a “correction parameter PZmn”. In the present embodiment, the correction parameter-determining unit 407 calculates the correction parameters PXmn, PYmn, and PZmn using expressions 16 to 18 below.

PXmn=CXmn÷KXmn (Expression 16)

PYmn=CYmn÷KYmn (Expression 17)

PZmn=CZmn÷KZmn (Expression 18)

Step 4-2

In addition, the correction parameter-determining unit 407 outputs the plurality of correction parameters (PX, PY, PZ) obtained in step 4-1 to the image-processing unit 408.

Correction Method of Input Image Data

A specific example of a correction method of input image data according to the present embodiment will be described.

Step 5-1

First, the image-processing unit 408 transforms the respective RGB values (Ri, Gi, Bi) of the input image data into XYZ tristimulus values (Xpi, Ypi, Zpi). In the present embodiment, the image-processing unit 408 transforms the RGB values (Ri, Gi, Bi) into XYZ tristimulus values (Xpi, Ypi, Zpi) using expression 19 below. Elements aX, aY, aZ, bX, bY, bZ, cX, cY, and cZ of the transformation matrix of expression 19 are determined in advance based on a measurement value of light emitted from a screen in a state where a distribution of light emitted from the light-emitting unit 402 is a corrected reference distribution.

$$\begin{matrix}[ Math . 2 ] & \\ ( \begin{matrix}Xpi \\ Ypi \\ Zpi\end{matrix} ) = ( \begin{matrix}aX & aY & aZ \\ bX & bY & bZ \\ cX & cY & cZ\end{matrix} ) ( \begin{matrix}Ri \\ Gi \\ Bi\end{matrix} ) & ( Expression 19 )\end{matrix}$$

Step 5-2

Next, for each of a plurality of divided display areas, the image-processing unit 408 multiplies the respective XYZ tristimulus values (Xpi, Ypi, Zpi) obtained in step 5-1 by the correction parameters PX, PY, and PZ. In the present embodiment, the XYZ tristimulus values after multiplication by the correction parameters PX, PY, and PZ will be described as “XYZ tristimulus values (Xoi, Yoi, Zoi)”. For example, with respect to an mth-row, nth-column divided display area, the image-processing unit 408 calculates the XYZ tristimulus values (Xoi, Yoi, Zoi) using expressions 20 to 22 below.

Xoi=PXmn×Xpi (Expression 20)

Yoi=PYmn×Ypi (Expression 21)

Zoi=PZmn×Zpi (Expression 22)

Step 5-3

In addition, the image-processing unit 408 retransforms the respective XYZ tristimulus values (Xoi, Yoi, Zoi) calculated in step 5-2 into RGB values (Ro, Go, Bo). In the present embodiment, the image-processing unit 408 retransforms the XYZ tristimulus values (Xoi, Yoi, Zoi) into the RGB values (Ro, Go, Bo) using expression 23 below. The transformation matrix in expression 23 is an inverse matrix of the transformation matrix in expression 19.

$$\begin{matrix}[ Math . 3 ] & \\ ( \begin{matrix}Ro \\ Go \\ Bo\end{matrix} ) = ( \begin{matrix}aR & aG & aB \\ bR & bG & bB \\ cR & cG & cB\end{matrix} ) ( \begin{matrix}Xoi \\ Yoi \\ Zoi\end{matrix} ) & ( Expression 23 )\end{matrix}$$

Effects

As described above, according to the present embodiment, an estimated light emission distribution is corrected based on a value of the estimated light emission distribution, profile data, and a displayed light emission pattern. Accordingly, information representing, with high accuracy, a distribution of light emitted from a light-emitting apparatus can be obtained. Specifically, information can be obtained which represents a distribution reflecting a variance in a shape of a distribution of light emitted from a light source unit and emitted from the light-emitting apparatus which is a variance attributable to a variance in a light emission pattern. Consequently, input image data, a light emission pattern, and the like can be corrected with high accuracy, and distribution of light from the light-emitting apparatus can be controlled to a desired distribution and image quality of a display image can be improved. Specifically, unintended brightness non-uniformity of light from the light-emitting apparatus, unintended color non-uniformity of light from the light-emitting apparatus, brightness shift of light from the light-emitting apparatus, color shift of light from the light-emitting apparatus, and the like can be suppressed with high accuracy. Brightness non-uniformity of a display image, color non-uniformity of the display image, brightness shift of the display image, color shift of the display image, and the like can also be suppressed with high accuracy.

Moreover, each functional unit shown in FIG. 4 may or may not be individual hardware. Functions of two or more functional units may be realized by common hardware. Each of a plurality of functions of a single functional unit may be realized by individual hardware. Two or more functions of a single functional unit may be realized by common hardware. In addition, each functional unit may or may not be realized by hardware. For example, an apparatus may include a processor and a memory storing a control program. In addition, functions of at least a part of the functional units included in the apparatus may be realized by having the processor read the control program from the memory and execute the control program.

It is to be understood that the embodiment described above is merely an example and that configurations obtained by appropriately modifying or altering the configuration of the embodiment described above without departing from the spirit and scope of the present invention are also included in the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-232504, filed on Nov. 30, 2016, which is hereby incorporated by reference herein in its entirety.

What is claimed is:

1. An information-processing apparatus configured to estimate a distribution of light emitted from a light-emitting apparatus including a plurality of light source units, the information-processing apparatus comprising:
at least one processor; and
at least one memory storing a program which, when executed by the at least one processor, causes the information-processing apparatus to:
acquire profile data related to a first distribution that is a distribution of light emitted from the light-emitting apparatus in a first emission pattern in which one light source unit in the plurality of light source units emits light;
estimate, based on the profile data and a second emission pattern in which two or more light source units in the plurality of light source units emit light, a second distribution that is a distribution of light emitted from the light-emitting apparatus in the second emission pattern; and
correct the estimated second distribution based on a difference between the first emission pattern and the second emission pattern.

2. The information-processing apparatus according to claim 1, wherein
the light-emitting apparatus is used in a display apparatus configured to display an image by modulating, based on input image data, light emitted from the light-emitting apparatus,
an emission state of each of the plurality of light source units is individually controlled based on the input image data, and
the second emission pattern is an emission pattern in which the emission state of each of the plurality of light source units is individually controlled based on the input image data.

3. The information-processing apparatus according to claim 1, wherein
a light emission surface of the light-emitting apparatus includes a plurality of partial areas respectively corresponding to the plurality of light source units,
for each of the plurality of partial areas, a first value is estimated based on an emission state of a light source unit corresponding to the partial area and on the profile data, the first value being a value of light emitted from the light-emitting apparatus in a case where the emission state of the light source unit corresponding to the partial area is controlled to an emission state corresponding to the second emission pattern, and
for each of the plurality of partial areas, a second value is corrected based on the first value of the partial area and the second value, the second value being a value of the second distribution in the partial area.

4. The image-processing apparatus according to claim 3, wherein
the second value is corrected in accordance with a difference between the first value and the second value.

5. The image-processing apparatus according to claim 4, wherein
the second value is corrected using a correction value that changes logarithmically with respect to a change in the difference between the first value and the second value.

6. The information-processing apparatus according to claim 1, wherein
the second distribution includes at least one of a brightness distribution and a color distribution.

7. The information-processing apparatus according to claim 1, wherein
the second distribution includes a plurality of distributions having mutually different types of values, and
each of the plurality of distributions is corrected using any of the values of the plurality of distributions.

8. The information-processing apparatus according to claim 7, wherein
the plurality of distributions include a distribution of an X value of XYZ tristimulus values, a distribution of a Y value of the XYZ tristimulus values, and a distribution of a Z value of the XYZ tristimulus values, and
each of the plurality of distributions is corrected using the X value, the Y value, or the Z value.

9. The information-processing apparatus according to claim 7, wherein
each of the plurality of light source units includes one or more light-emitting elements configured to emit blue light,
the light-emitting apparatus further includes a converting member configured to convert a wavelength of the blue light emitted from the plurality of light source units,
the plurality of distributions include a distribution of a Z value of XYZ tristimulus values, and
each of the plurality of distributions is corrected using the Z value.

10. The information-processing apparatus according to claim 9, wherein
the converting member includes a quantum dot configured to convert a wavelength of the blue light emitted from the plurality of light source units.

11. The information-processing apparatus according to claim 1, wherein
the light-emitting apparatus is used in a display apparatus configured to display an image by modulating, based on input image data, light emitted from the light-emitting apparatus, and
the program, when executed by the processor, further causes the information-processing apparatus to determine, based on the second distribution after correction, a correction parameter for correcting at least one of the input image data and the second emission pattern.

12. The information-processing apparatus according to claim 1, wherein
the information-processing apparatus is the light-emitting apparatus.

13. The information-processing apparatus according to claim 1, wherein
the information-processing apparatus is a display apparatus including the light-emitting apparatus and a display unit configured to display an image by modulating, based on input image data, light emitted from the light-emitting apparatus.

14. An information-processing method for estimating a distribution of light emitted from a light-emitting apparatus including a plurality of light source units, the information-processing method comprising:
acquiring profile data related to a first distribution that is a distribution of light emitted from the light-emitting apparatus in a first emission pattern in which one light source unit in the plurality of light source units emits light;
estimating, based on the profile data and a second emission pattern in which two or more light source units in the plurality of light source units emit light, a second distribution that is a distribution of light emitted from the light-emitting apparatus in the second emission pattern; and
correcting the estimated second distribution based on a difference between the first emission pattern and the second emission pattern.

15. A non-transitory computer readable medium that stores a program, wherein
the program causes a computer to execute an information-processing method for estimating a distribution of light emitted from a light-emitting apparatus including a plurality of light source units, and
the information-processing method includes:
acquiring profile data related to a first distribution that is a distribution of light emitted from the light-emitting apparatus in a first emission pattern in which one light source unit in the plurality of light source units emits light;
estimating, based on the profile data and a second emission pattern in which two or more light source units in the plurality of light source units emit light, a second distribution that is a distribution of light emitted from the light-emitting apparatus in the second emission pattern; and
correcting the estimated second distribution based on a difference between the first emission pattern and the second emission pattern.
